(19) United States
(12) Patent Application Publication
(10) Pub. No.: US 2026/0266125 A1
(43) Pub. Date: Sep. 10, 2026

(54) GLAZING HAVING IMPROVED SOUNDPROOFING PERFORMANCE

(71) Applicant: SAINT-GOBAIN GLASS FRANCE, COURBEVOIE (FR)

(72) Inventors: Ahmed ABBAD, COURBEVOIE (FR); Gérald MERCIER, COURBEVOIE (FR)

(21) Appl. No.: 19/166,277

(22) PCT Filed: Mar. 14, 2024
(86) PCT No.: PCT/EP2024/056753

§ 371 Date: Sep. 17, 2025

(30) Foreign Application Priority Data
Mar. 17, 2023 (FR) FR2302473

(51) Int. Cl. E06B 3/67

(52) U.S. Cl. CPC E06B 3/6707

(57) ABSTRACT

A glazing includes at least two glazed walls forming a cavity therebetween, wherein the cavity includes at least one acoustic insulation device including at least one polymer foam plate, the polymer foam plate including a plurality of perforations that are arranged periodically and define a chamber arranged in the cavity.

### PRIOR ART

The present invention belongs to the general field of manufacturing glazings. More particularly, it relates to an acoustic insulation device configured to improve the acoustic insulation performance of a glazing and, preferably, to limit the presence of moisture between the glass walls of said glazing. It also relates to glazings comprising at least one such device. The invention finds a particularly advantageous application, although by no means limiting, in the case of building glazings.

Double glazings consisting of two glass panes separated by a cavity filled with gas, typically air, are conventionally used in windows and facades of buildings for their thermal and acoustic insulation performance.

However, the loss of transmission of the sound caused by such double glazings decreases for frequencies surrounding the frequency referred to as “mass/spring/mass” corresponding to the resonant frequency of the double glazings and located in the low frequencies. This phenomenon, called the mass/spring/mass effect, is due to significant variations in pressure in the air cavity at the mass/spring/mass frequency.

Also, different solutions have been developed in order to improve the acoustic insulation performance of the glazing. For example, document WO 2022/234237 relates to a glazing comprising at least two glazed walls forming a cavity between them, wherein the cavity comprises at least one device comprising at least one plate, said plate comprising a plurality of perforations arranged periodically and delimiting a chamber arranged in the cavity.

There is a need to provide another system making it possible to improve the acoustic insulation properties of glazing, particularly in the low frequencies, and preferably the performance in terms of moisture absorption thereof.

### OVERVIEW OF THE INVENTION

The present invention aims to remedy some or all of the disadvantages of the prior art, in particular those set out above, by proposing a solution that allows a glazing to be obtained which is much more effective than the solutions of the prior art in terms of acoustic insulation. In advantageous embodiments, the manufacturing method is further simplified.

Thus, and according to a first aspect, the invention relates to a glazing comprising at least two glazed walls forming a cavity between them, wherein the cavity comprises at least one acoustic insulation device comprising at least one polymer foam plate, said at least one polymer foam plate comprising a plurality of perforations arranged periodically and delimiting a chamber arranged in the cavity.

In particular embodiments, the glazing may further comprise several of the following features, taken alone or in any technically feasible combinations.

In some embodiments, the acoustic insulation device comprises a profile or casing formed from a plurality of polymer foam walls, the chamber being an inner space of the profile or casing delimited by the walls, and the polymer foam plate comprising the plurality of periodically arranged perforations being one of the walls of the profile or casing.

In some embodiments, the acoustic insulation device is a spacer device of the glazing.

In some embodiments, the acoustic insulation device comprises an inner part facing the chamber and an outer part facing away from the inner part, the average proportion of open cells of the polymer foam in the inner part being greater than the proportion of open cells in the outer part; and preferably the average proportion of open cells of the polymer foam in the inner part is between 30% and 99%.

In some embodiments, the acoustic insulation device is a one-piece unit.

In some embodiments, the acoustic insulation device comprises at least one rectilinear bar forming said at least one polymer foam plate, associated with a spacer device, the chamber being delimited by the polymer foam plate and by an edge of the glazing.

In some embodiments, the polymer foam comprises an average proportion of open cells of 30 to 99%, preferably 65 to 98%.

In some embodiments, the polymer foam is selected from the group consisting of silicone foams, polyurethane foams, polyethylene foams, melamine foams, and combinations thereof.

In some embodiments, the glazing comprises a desiccant agent in or associated with the acoustic insulation device.

In some embodiments, the desiccant agent is incorporated into the polymer foam.

In some embodiments, the desiccant agent is arranged in at least one envelope, which is preferably held inside or outside the chamber.

In some embodiments, said at least one polymer foam plate comprises at least three perforations, preferably at least four perforations.

In some embodiments, the glazing further comprises one or more additional acoustic insulation devices, each additional acoustic insulation device comprising a plate comprising a plurality of periodically arranged perforations and delimiting a chamber arranged in the cavity, wherein preferably the periodicity of the perforations of said polymer foam plate and said plate of each additional acoustic insulation device are different from one another.

In some embodiments, the plate of each additional acoustic insulation device comprises a polymer foam.

In some embodiments, the acoustic insulation device is positioned in a peripheral zone of the cavity of the glazing.

In some embodiments, the glazing is a glazing of a building, such as a glazing of a building facade, of a window or of a door of a building, or an interior glazing.

The invention also relates to an acoustic insulation device comprising at least one polymer foam plate, said plate comprising a plurality of perforations arranged periodically, said device being suitable for manufacturing the glazing as described above.

The present invention makes it possible to meet the need expressed herein before. In particular, it provides a glazing device that is easy and simple to manufacture, relatively light and compact, while at the same time enabling a glazing with improved sound insulation to be obtained.

This is accomplished by virtue of the presence, in the device, of a polymer foam plate comprising a plurality of perforations arranged periodically, said plate allowing the formation of a chamber. Such a device enables a double acoustic effect, which is achieved by the absorption of sound energy by said chamber and said plurality of perforations, as well as by the absorption of sound energy by said polymer foam. The combination of the presence of said chamber with the presence of perforations on the plate, these perforations being periodic, allows the creation of resonators making it possible to absorb at least part of the sound energy in the cavity of the glazing formed by the two glass walls, which makes it possible to reduce the transmission of sound through the glazing. In particular, the resonators absorb the sound energy significantly for frequencies close to their resonant frequency(ies). In addition, the energy absorption also for the harmonic frequencies of the resonators as well as physical phenomena related to the modification of the properties of the gas cavity of the glazing, due to the presence of the resonators, make it possible to also improve acoustic insulation at frequencies higher than the resonant frequencies of the resonators. In addition, the polymer foam of the plate further enhances acoustic insulation by absorbing at least part of the sound energy itself, by virtue of its porous structure. Thus, the device of the present invention, which incorporates sound absorption capabilities, is easy to manufacture while offering improved acoustic insulation performance.

### BRIEF DESCRIPTION OF THE DRAWINGS

Other features and advantages of the present invention will emerge from the non-limiting description given below, with reference to the appended drawings that illustrate an exemplary embodiment thereof. In the figures:

FIG. 1 On the left, FIG. 1 shows an example glazing according to the invention and, on the right, an enlarged schematic perspective view of an example device according to the invention in the form of a profile present in this example glazing (first variant);

FIG. 2 shows a schematic longitudinal section view of an example device according to the invention in the form of a casing (second variant);

FIG. 3, On the left, FIG. 3 shows another example glazing according to the invention and, on the right, an enlarged schematic perspective view of an example device according to the invention in the form of a casing present in this example glazing (second variant);

FIG. 4 On the left, FIG. 4 shows another example of glazing according to the invention and, on the right, an enlarged schematic perspective view of an example of a device according to the invention in the form of a box present in this example glazing (third variant);

FIG. 5 On the left, FIG. 5 shows another example glazing according to the invention and, on the right, an enlarged schematic perspective view of an example device according to the invention in the form of a bar present in this example glazing (fourth variant);

FIG. 6 shows schematically, in a longitudinal section view in plane XZ, a particular embodiment of the device shown in FIG. 1 or FIG. 3;

FIG. 7 shows schematically, in a longitudinal section view in plane XZ, another particular embodiment of the device shown in FIG. 1 or FIG. 3.

### DESCRIPTION OF EMBODIMENTS

The invention is disclosed below in greater detail and in a non-limiting manner in the following disclosure.

The invention relates firstly to an acoustic insulation device for glazing.

The following description is intended firstly to describe, in a number of embodiments, configuration aspects of said device enabling the glazing equipped therewith to provide an excellent performance in terms of acoustic insulation.

The glazing may be any type of glazing comprising at least two glazed walls defining a cavity therebetween. Within the meaning of the present invention, the cavity of a glazing is defined as being the volume between two glazed walls of said glazing.

The device according to the invention may be or may comprise a spacer device for a glazing. “Spacer device” means any device making it possible to set the length of the spacing between the glazed walls of the glazing wherein it is intended to be placed.

Alternatively, the device according to the invention may not be used as a spacer device but be associated with a spacer device.

The device according to the invention comprises at least one polymer foam plate comprising a plurality of perforations arranged periodically (also referred to as “polymer foam perforated plate” or “perforated plate” hereinafter). “Polymer foam” is understood to mean a material with a porous structure, which is composed of a large number of small air bubbles, called “cells”, in a solid polymer matrix.

The polymer foam plate comprises two main faces opposite one another and bearing the perforations, referred to in this text as the “inner face” (corresponding to the face oriented toward the center of the cavity formed between the glazed walls of the glazing) and the “outer face”, which is opposite the inner face.

It is possible to define for the polymer foam perforated plate a length, corresponding to the largest dimension of the plate in the plane of its main faces (also referred to as “main plane of the plate”), a width, corresponding to the dimension of the plate in a direction perpendicular to the direction of the length of the plate, in the main plane of the plate, and a thickness, corresponding to the dimension of the plate in a direction perpendicular to the main plane of the plate (and therefore corresponding to the dimension of the plate between its two main faces).

The polymer foam perforated plate is preferably rectangular and parallelepiped (that is to say, it has a constant length, width and thickness).

When the device according to the invention is a spacer device, the width of the polymer foam perforated plate preferably determines the length of the spacing between the glazed walls (that is to say, the thickness of the cavity between the glazed walls) of the glazing wherein the spacer device is intended to be used. The polymer foam plate can have a width of 6 to 30 mm, preferably of 10 to 20 mm, for example 16 mm or 20 mm, in particular in the embodiments wherein the device is a spacer device.

The thickness of the polymer foam perforated plate is advantageously from 0.1 to 15 mm, more preferentially from 0.2 to 1 mm. In particular, the polymer foam perforated plate may have a thickness of 0.1 to 0.2 mm, or of 0.2 to 0.4 mm, or of 0.4 to 0.6 mm, or of 0.6 to 0.8 mm, or of 0.8 to 1 mm, or of 1 to 1 to 1.2 mm, or of 1.2 to 1.5 mm, or of 1.5 to 2 mm, or of 2 to 3 mm, or of 3 to 4 mm, or of 4 to 5 mm, or of 5 to 10 mm, or of 10 to 15 mm.

The polymer foam plate may be manufactured by any method known to a person skilled in the art. For example, the polymer foam plate is manufactured by injection molding. A physical and/or chemical expansion agent can be used to expand the polymer, for example in the mold. Alternatively, the plate can be manufactured using an extrusion foaming technique.

The polymer foam of the plate of the invention can be selected from the group consisting of silicone foams, polyurethane foams, polyolefin foams (and in particular polyethylene foams), melamine foams, and combinations thereof. The polymer foam is preferably a silicone foam or a polyurethane foam.

The polymer foam of the plate can be characterized by an average porosity greater than or equal to 0.7 and/or an average air resistivity of 5,000 to 150,000 N·s·^{m-4}. The porosity of the material can be measured using a porometer according to the fluid saturation method, by mercury intrusion. Airflow resistivity can be measured according to standard NF EN ISO 9053-1. Such a porous structure of the polymer foam can make it possible to increase the acoustic performance of the device and therefore to further improve the acoustic insulation of the glazing wherein it is placed.

The polymer foam of the plate may have an average porosity greater than or equal to 0.75, or greater than or equal to 0.8, or greater than or equal to 0.85, or greater than or equal to 0.9, or greater than or equal to 0.95, for example a porosity of 0.7 to 0.75, or of 0.75 to 0.8, or of 0.8 to 0.85, or of 0.85 to 0.90, or of 0.90 to 0.95, or of 0.95 to 0.99. In a particularly preferred way, the polymer foam of the plate has an average porosity of 0.7 to 0.99, and more preferentially greater than or equal to 0.9. The average air resistivity of the polymer foam may be from 5,000 to 10,000 N·s·m⁻⁴, or from 10,000 to 20,000 N·s·m⁻⁴, or from 20,000 to 40,000 N·s·m⁻⁴, or from 40,000 to 60,000 N·s·m⁻⁴, or from 60,000 to 80,000 N·s·m⁻⁴, or from 80,000 to 100,000 N·s·m⁻⁴, or from 100,000 to 120,000 N·s·m⁻⁴, or from 120,000 to 140,000 N·s·m⁻⁴, or from 140,000 to 150,000 N·s·m⁻⁴. Preferably, the polymer foam of the plate has an average air resistivity which is from 20,000 to 100,000 N·s·m⁻⁴.

Advantageously, the polymer foam of the plate can comprise an average proportion of open cells of 30 to 100%, preferably 30 to 99%, even more preferably 65 to 98%. The average proportion of open cells can be measured using a microscope. For example, a cross section of a polymer foam can be examined under a microscope to determine whether each cell is open or closed. The average proportion of open cells is then calculated by dividing the total number of open cells by the total number of cells. The microscope can be, for example, an optical microscope or a scanning electron microscope. Alternatively, the average proportion of open cells can be measured using an ultrasonic tortuosimeter by measuring the characteristic lengths of a polymer foam (e.g. viscous and thermal characteristic lengths), which are then used to calculate the foam's porosity and thus determine the open cell rate.

The polymer foam of the plate can comprise an average proportion of open cells of 0 to 70%, preferably 1 to 70%, even more preferably 2 to 35% %. The average proportion of closed cells can be measured in the same way as the average proportion of open cells.

“Open cells” and “closed cells” are understood to mean, respectively, cells that are interconnected with one another (that is to say there are open passages between cells), and cells that are isolated from one another (that is to say there are no open passages between cells). In general, open-cell foams have better acoustic absorption capacity due to the transmission of the sound wave between the cells, while closed-cell foams have greater rigidity. Of course, the rigidity and sound absorption capacity of the polymer foam depend on various factors, such as foam density, cell size and chemical composition.

In some embodiments, the average proportion of open cells in the polymer foam of the plate may be, for example, greater than or equal to 30%, 40%, 50%, 60%, 65%, 70%, 75%, 80%, 85%, 90%, 95% or about 100%. When the device is not a spacer device, the average proportion of open cells is preferably about 100%. The average proportion of closed cells in the polymer foam of the plate may be, for example, less than or equal to 70%, 60%, 50%, 40%, 35%, 30%, 25%, 20%, 15%, 10%, 5%, 2%, 1% or about 0%. When the device is not a spacer device, the average proportion of closed cells is preferably about 0%.

The polymer foam plate comprises a plurality of perforations arranged periodically. “Plurality of perforations” means at least two perforations. More particularly, the polymer foam plate may comprise two, or three, or at least three, or four, or at least four, or five, or at least five, or six, or at least six, or seven, or at least seven, or eight, or at least eight, or nine, or at least nine, or ten, or at least ten, perforations arranged periodically. The more perforations are arranged periodically in the polymer foam plate, the more the acoustic insulation of the glazing wherein the device is present is improved. In a particularly preferred way, the polymer foam plate comprises at least three perforations, more preferentially at least four perforations, arranged periodically.

“Perforations arranged periodically” means that said perforations are identical and are present at regular intervals in the polymer foam plate (that is to say that the distance between the centers of two adjacent perforations is essentially constant). The perforations are made through the entire thickness of the polymer foam plate (they extend from the inner face of the polymer foam plate to its outer face) and allow fluid communication between the spaces located on either side of said polymer foam plate (that is to say that they allow the circulation of a fluid, and more particularly of a gas, from one space to the other). Advantageously, the periodic perforations are all aligned, more preferentially along a longitudinal axis of the polymer foam plate (that is to say, in the direction of its length). Even more advantageously, the perforations are arranged along a longitudinal axis of the polymer foam plate located at the middle of the width of the polymer foam plate.

The perforations may be made by any method known to a person skilled in the art. Depending on the method, perforations can be made during device extrusion (in-line) or using drilling technology (off-line) as an additional step of the method.

The perforations may have any suitable shape. In certain embodiments, they have a cross section (that is to say, in the main plane of the polymer foam plate) which is circular or substantially circular.

Advantageously, the perforations of the polymer foam plate are microperforations. “Microperforations” means holes of which the diameter or maximum dimension (in the main plane of the polymer foam plate) is less than or equal to 8 mm. Preferably, the perforations have a diameter, or a maximum dimension (in the main plane of the polymer foam plate), of 0.2 to 8 mm, more preferentially of 0.5 to 8 mm. In some embodiments, the diameter or the maximum dimension of the perforations may be of 0.2 to 0.5 mm, or of 0.5 to 1 mm, or of 1 to 2 mm, or of 2 to 3 mm, or of 3 to 4 mm, or of 4 to 5 mm, or of 5 to 6 mm, or of 6 to 7 mm, or of 7 to 8 mm.

In a particularly preferred way, the periodic perforations are distributed over the entire length of the polymer foam plate. Alternatively, the perforations can be arranged periodically over only part of the length of the polymer foam plate, for example over a portion of the polymer foam plate having a length less than or equal to 90%, or less than or equal to 80%, or less than or equal to 70%, or less than or equal to 60%, or less than or equal to 50%, or less than or equal to 40%, or less than or equal to 30%, or less than or equal to 20%, or less than or equal to 10%, of the length of the polymer foam plate.

For each perforation, a geometric center of said perforation may be defined (simply referred to as “center” hereinafter). The distance between the centers of two adjacent perforations is preferably from 5 to 200 mm, more preferentially from 10 to 110 mm. The distance between the centers of two adjacent periodic perforations can be from 5 to 10 mm, or from 10 to 20 mm, or from 20 to 30 mm, or from 30 to 40 mm, or from 40 to 50 mm, or from 50 to 60 mm, or from 60 to 70 mm, or from 70 to 80 mm, or from 80 to 90 mm, or from 90 to 100 mm, or from 100 to 110 mm, or from 110 to 120 mm, or from 120 to 140 mm, or from 140 to 160 mm, or from 160 to 180 mm, or from 180 to 200 mm.

Advantageously, the open area ratio (that is to say, the ratio of the surface area of all the perforations arranged periodically and the total surface area of the polymer foam plate (including the surface of the perforations)) is from 0.01 to 8%, preferably from 0.05 to 0.8%. The open area ratio can be from 0.01 to 0.05%, or from 0.05 to 0.1%, or from 0.1 to 0.2%, or from 0.2 to 0.3%, or from 0.3 to 0.4%, or from 0.4 to 0.5%, or from 0.5 to 0.6%, or from 0.6 to 0.7%, or from 0.7 to 0.8%, or from 0.8 to 0.9%, or from 0.9 to 1%, or from 1 to 2%, or from 2 to 3%, or from 3 to 4%, or from 4 to 5%, or from 5 to 6%, or from 6 to 7%, or from 7 to 8%.

The perforated polymer foam plate delimits a chamber, in the device itself or in the glazing wherein this device is arranged. The chamber is located inside the cavity of the glazing.

The thickness of the chamber is preferably from 2 to 200 mm, more preferentially from 5 to 50 mm. The thickness of the chamber corresponds to the dimension of the chamber in a direction perpendicular to the main plane of the polymer foam plate. In some embodiments, the chamber has a thickness of 2 to 5 mm, or of 5 to 10 mm, or of 10 to 20 mm, or of 20 to 30 mm, or of 30 to 40 mm, or of 40 to 50 mm, or of 50 to 60 mm, or of 60 to 70 mm, or of 70 to 80 mm, or of 80 to 90 mm, or of 90 to 100 mm, or of 100 to 120 mm, or of 120 to 140 mm, or of 140 to 160 mm, or of 160 to 180 mm, or of 180 to 200 mm.

The sizing and configuration of the polymer foam plate, its perforations and the chamber can be selected as a function of the frequency at which the assembly formed of the polymer foam plate and the chamber is sought to resonate. Indeed, the relationship between the resonant frequency f of the perforated polymer foam plate and the thickness of the polymer foam plate, the thickness of the chamber, the spacing between the perforations and the size and distribution of the perforations may be estimated by the formula:

$$f = 54000 \cdot \sqrt{\frac{σ}{( L + 0.8 D ) d}} \qquad [ Math . 1 ]$$

In equation 1, σ is the open surface ratio (depending on the size of the perforations and their distribution), L is the thickness of the polymer foam plate in m, D is the thickness of the chamber in m and d is the distance between the centers of two adjacent perforations in m.

Advantageously, the system consisting of the polymer foam plate and the chamber is configured to resonate in the low frequencies. “Low frequencies” means sound waves with a frequency of less than 300 Hz. For example, the system consisting of the polymer foam plate and the chamber can be configured to resonate at a frequency less than or equal to 250 Hz, or less than or equal to 225 Hz, or less than or equal to 200 Hz, or less than or equal to 175 Hz, or less than or equal to 150 Hz. In other embodiments, the system consisting of the polymer foam plate and the chamber can be configured to resonate at a frequency less than or equal to 400 Hz, or less than or equal to 350 Hz.

The polymer foam plate preferably comprises a single series of perforations arranged periodically. Alternatively, it may comprise several series of perforations arranged periodically in the polymer foam plate, such as at least two series or at least three series, each series being different from the others (for example, the dimension of the perforations and/or the distance between the centers of two adjacent perforations can be different in each series). When the polymer foam plate comprises several series of periodic perforations, each series is located in a different portion of the polymer foam plate (along its length). The presence of several different series of periodic perforations allows the system consisting of the polymer foam plate and the chamber to resonate at several frequencies, each portion of the assembly of the polymer foam plate and the chamber which comprises a series of different periodic perforations having a different resonant frequency.

The perforations may be covered by a fabric, in part or, preferably, entirely. For example, the fabric can be bonded by any suitable means onto the polymer foam plate, such as onto the inner face of the polymer foam plate. The fabric thus forms against the perforations a screen having a certain resistivity. Without seeking to be bound by any one theory, the inventors estimate that when the sound wave passes through the fabric in order to penetrate the chamber, it encounters a resistivity due to the presence of the fabric, which improves the absorption of the sound energy and therefore the acoustic insulation of the glazing comprising the device at the low, medium and high frequencies. The fabric advantageously has a thickness ranging from 0.1 to 3 mm, preferably from 0.2 to 1 mm. The fabric may be made of any woven natural or synthetic fibers, such as for example cotton fibers and/or flax fibers. The fabric preferably has a porosity of 0.07 to 0.99, and more preferentially of 0.5 to 0.99, and/or an air resistivity of 90,000 to 3,500,000 N·s·m⁻⁴, more preferentially from 300,000 to 3,000,000 N·s·m⁻⁴. The air resistivity and the porosity can be measured as indicated hereinbefore. The fabric may have a porosity of 0.07 to 0.2, or of 0.2 to 0.4, or of 0.4 to 0.6, or of 0.6 to 0.8, or of 0.8 to 0.99. The air resistivity of the fabric may be from 90,000 to 300,000 N·s·m⁻⁴, or from 300,000 to 500,000 N·s·m⁻⁴, or from 500,000 to 1,000,000 N·s·m⁻⁴, or from 1,000,000 to 1,500,000 N·s·m⁻⁴, or from 1,500,000 to 2,000,000 N·s·m⁻⁴, or from 2,000,000 to 2,500,000 N·s·m⁻⁴, or from 2,500,000 to 3,000,000 N·s·m⁻⁴, or from 3,000,000 to 3,500,000 N·s·m⁻⁴.

The interior of the chamber may comprise a gas, and optionally be covered with a fabric as described above.

Advantageously, the polymer foam plate as described above is a one-piece unit. “One-piece unit” is understood to mean that the polymer foam plate is made up of a single piece, with no visible joints or separate parts. For example, the polymer foam plate is manufactured as a one-piece unit by injection molding.

In some preferred embodiments, the invention also consists in equipping the acoustic insulation device for glazing with a desiccant agent configured to absorb moisture. By “desiccant agent”, reference is typically made to an agent which has the property of drying the atmosphere wherein it is placed, or, in other words, of absorbing all or part of the moisture contained in this atmosphere. The use of such a desiccant agent reflects a desire to absorb moisture before it turns to water. The desiccant agent may be present in or associated with the acoustic insulation device.

The desiccant agent may comprise granules, preferentially in a non-agglomerated (that is to say individualized) form. These granules are made, for example, of molecular sieve, silica gel, calcium chloride (CaCl₂)), sodium sulfate (Na₂SO₄), activated carbon, or zeolites with the chemical formulation M₂/nO·Al₂O₃·xSiO₂·yH₂O, where M can designate Ca, Mg, K or Na. In general, any material known to a person skilled in the art for producing desiccant agents can be used as granules.

The desiccant agent can be integrated into the polymer foam plate. For example, the granulated desiccant agent is held in a fixed position in the polymer foam plate in a homogeneous manner. This advantageously prevents any release of granules through the perforations in the polymer foam plate. For example, it can be mixed with the polymer prior to foam production.

Alternatively, the desiccant agent can be arranged in at least one envelope, which is preferably held inside or outside the chamber. Each envelope can comprise the desiccant agent in granulated form as described above. Each envelope can be made of a flexible or rigid material, such as for example paper, plastic, polymer or plant or woven fibers. Said envelope can be perforated to allow the granules to absorb moisture. These perforations are typically smaller in diameter than the granules, to prevent them from escaping from the envelope containing them.

The acoustic insulation device according to the invention can be in the form of a profile or a casing and comprise a plurality of polymer foam walls. In this case, the chamber is an inner space of the profile or casing delimited by the walls, and the polymer foam plate comprising a plurality of periodically arranged perforations is one of the walls of the profile or casing.

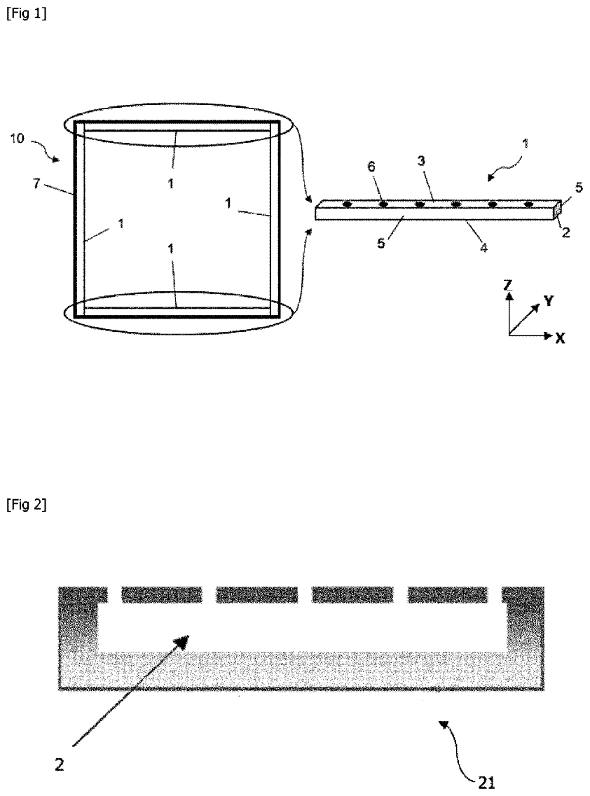

Referring to FIG. 1, in a first variant, the acoustic insulation device according to the invention is in the form of a profile, attached to each of the two glazed walls, and formed by a plurality of polymer foam walls. The chamber can be an inner space of the profile delimited by the walls, and the polymer foam plate comprising a plurality of periodically arranged perforations, as described above, is one of the walls of the profile. “Profile” is understood to mean a hollow tubular structure, the chamber being the internal space of this tubular structure. The profile can be a straight profile. “Rectilinear profile” means that the profile is straight in the direction of its length (a longitudinal axis of the profile may therefore be defined). According to this variant, the device is advantageously a spacer device for the glazing.

In this first variant, what has been described above about the polymer foam of the polymer foam plate applies to all the walls of the device, which are made of the same material.

The acoustic insulation device 1 according to the first variant may comprise an inner part facing the chamber 2 and an outer part facing away from the inner part. The inner part corresponds to a region of the device that comprises the inner surface of the various walls, which delimits the chamber. The outer part corresponds to a region of the device that comprises the outer surface of the various walls (opposite the inner surface). What is referred to above as the inner face of the polymer foam plate forms part of the outer surface of the device. What is referred to above as the outer face of the polymer foam plate forms part of the inner surface of the device. For example, the outer part and the inner part can each extend over about half the thickness of the walls.

Advantageously, in this variant, the average proportion of open cells of the polymer foam in the inner part is greater than the proportion of open cells in the outer part. Advantageously, the average proportion of closed cells of the polymer foam in the outer part is greater than the proportion of closed cells in the inner part. Such a gradient of open and closed cells in the device ensures that the device has sufficient mechanical strength to perform its function as a spacer device, while at the same time providing effective absorption of sound waves. Preferably, the average proportion of open cells of the polymer foam in the inner part (and in particular on the inner surface) is from 30 to 100%, preferably from 65 to 100%, more preferably from 70 to 100%, more preferably from 80 to 100%, more preferably from 85 to 100%, more preferably from 90 to 100%, more preferably from 95 to 100%. Preferably, the average proportion of closed cells of the polymer foam in the outer part (and in particular on the outer surface) is from preferably from 65 to 100%, preferably from 70 to 100%, more preferably from 80 to 100%, more preferably from 85 to 100%, more preferably from 90 to 100%, more preferably from 95 to 100%.

Alternatively or additionally, the density of the polymer foam in the inner part can be lower than the density of the polymer foam in the outer part. Alternatively or additionally, the size of the cells in the inner part can be larger than the size of the cells in the outer part.

Foam with such a cell gradient can be obtained by controlled curing and expansion in a mold according to methods well known to the skilled person.

Referring again to FIG. 1, in some embodiments, the profile comprises at least an upper wall 3, a lower wall 4, two side walls 5 defining the profile chamber 2. In the present text, the terms “upper” and “lower” are used referring to the orientation of the profile 1 shown on the right-hand side of FIG. 1. Of course, the profile may have any other possible orientation, such as, for example, an orientation according to which the longitudinal axis of the profile is vertical or an orientation according to which the upper wall is below the lower wall (as shown in the left-hand side of FIG. 1). The profile can have open ends in the longitudinal direction. However, the profile chamber can be closed by sealing the open ends of the profile (e.g. against the upper wall of another profile, as shown in the figure).

The upper wall 3 comprises a plurality of perforations 6 arranged periodically. Thus, the profile 1 is also referred to as “perforated profile” in the present text. The perforations 6 are made over the entire thickness of the upper wall and place the chamber 2 of the profile in fluid communication with the environment outside the profile (that is to say that they allow the circulation of a fluid, and more particularly a gas, from the chamber 2 of the profile toward the outside environment and vice versa).

In this first variant, the upper wall 3 of the profile corresponds to the polymer foam plate comprising a plurality of perforations arranged periodically of the device described hereinbefore, and the chamber 2 of the profile corresponds to the chamber delimited by the polymer foam plate described hereinbefore. Thus, all that is described in the present text in relation to the perforated polymer foam plate and in relation to the chamber delimited by the perforated polymer foam plate applies to the upper wall 3 of the profile 1 and to the chamber 2 of the profile, respectively. Similarly, everything described in this text in relation to polymer foam applies to the polymer foam walls of the profile 1.

In this variant, the thickness of the chamber inside the profile 1 is the distance between the upper wall 3 and the lower wall 4 of the profile 1.

The upper wall 3 of the profile corresponds to the wall intended to face the center of the cavity formed between the glazed walls 7 of the glazing 10, the lower wall 4 corresponds to the wall of the profile 1 intended to be closest to the edge of the glazed walls 7 of the glazing 10, the longitudinal side walls 5 are intended to be parallel to the glazed walls 7.

The upper wall 3 and the lower wall 4 of the profile may be connected by two side walls 5 (each of the two side walls 5 connecting a longitudinal edge of the upper wall 3 to a longitudinal edge of the lower wall 4). In other less preferred embodiments, the upper wall 3 and the lower wall 4 can be connected to each other by any number of walls. The upper wall 3 and the lower wall 4 of the profile are preferably connected to each other by two transverse side walls 8 (each of the two transverse side walls 8 connecting a transverse edge of the upper wall 3 to a transverse edge of the lower wall 4).

Advantageously, the main plane of the upper wall 3 and the main plane of the lower wall 4 are parallel to each other. Even more advantageously, the main planes of the upper 3 and lower 4 walls are perpendicular to the main planes of the two side walls 5.

Preferably, the profile 1 according to the invention has a parallelepiped shape, even more preferentially a rectangular parallelepiped shape.

Each of the walls of the profile 1 can independently have a rectangular parallelepiped shape, preferably each of the walls of the profile 1 has a rectangular parallelepiped shape. The thickness of each wall is advantageously from 0.1 to 15 mm, more preferentially from 0.2 to 1 mm. In particular, each wall may have a thickness of 0.1 to 0.2 mm, or of 0.2 to 0.4 mm, or of 0.4 to 0.6 mm, or of 0.6 to 0.8 mm, or of 0.8 to 1 mm, or of 1 to 1 to 1.2 mm, or of 1.2 to 1.5 mm, or of 1.5 to 2 mm, or of 2 to 3 mm, or of 3 to 4 mm, or of 4 to 5 mm, or of 5 to 10 mm, or of 10 to 15 mm.

In one particular example, the upper wall is thinner than the other walls (lower wall and side walls).

Advantageously, the length of the upper wall 3 of the profile 1 is equal to the length of the cavity between the glazed walls 7 of the glazing 10 wherein the device is intended to be placed, in the same direction.

Advantageously, the device is a single-piece unit. For example, the device can be manufactured in a single piece by injection molding or extrusion.

The perforations may be made by any method known to a person skilled in the art. Depending on the method, perforations can be made during device extrusion (in-line) or using drilling technology (off-line) as an additional step of the method.

Alternatively, the acoustic insulation device according to the invention can be in the form of a casing. “Casing” means a hollow closed structure, that is to say, comprising a cavity or chamber.

In this second variant, what has been described above about the polymer foam of the polymer foam plate applies to all the walls of the device, which are made of the same material.

As in the first variant, the device according to the second variant may comprise an inner part facing the chamber 2 and an outer part facing away from the inner part (as shown by FIG. 2). The average proportion of open cells of the polymer foam in the inner part (and in particular on the inner surface), the average proportion of closed cells of the polymer foam in the outer part (and in particular on the outer surface), the cell gradient in the foam, the methods for obtaining such a cell gradient, the thickness of each wall are as defined above in relation to the first variant (profile).

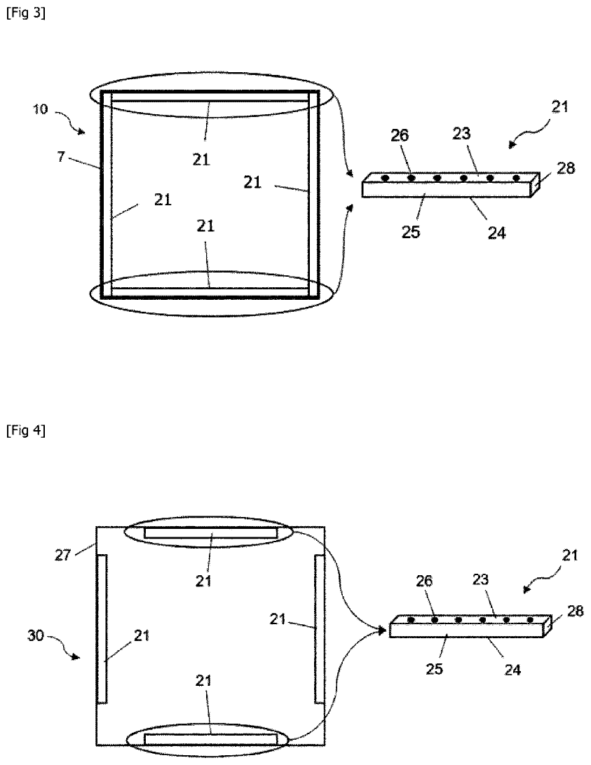

In reference to FIG. 2 and FIG. 3, the casing 21 comprises at least an upper wall 23, a lower wall 24, two longitudinal side walls 25 (preferably opposite each other) and two transverse side walls 28 (preferably opposite each other) defining the chamber of the casing. “Longitudinal side wall” means a side wall parallel to the longitudinal axis of the rectilinear casing, and “transverse side wall” means a side wall perpendicular to the longitudinal axis of the rectilinear casing (situated at a longitudinal end of the casing). In the present text, the terms “upper” and “lower” are used referring to the orientation of the casing 21 shown on the right-hand side of FIG. 3. Of course, the casing can have any other possible orientation, as shown for example on the left-hand side of FIG. 3. The upper wall 23 of the casing corresponds to the wall intended to face the center of the cavity formed between the glazed walls 7 of the glazing 10, the lower wall 24 corresponds to the wall of the casing 21 intended to be closest to the edge of the glazed walls 7 of the glazing 10, the longitudinal side walls 25 are intended to be parallel to the glazed walls 7 and the transverse side walls 28 are intended to be perpendicular to the glazed walls 7.

Advantageously, the length of the upper wall 23 of the casing 21 is equal to the length of the cavity between the glazed walls 7 of the glazing 10 wherein the device is intended to be placed, in the same direction.

According to this second variant, the device is (consists of) advantageously a spacer device.

The upper wall 23 and the lower wall 24 of the casing can be connected by two longitudinal side walls 25 (each of the two longitudinal side walls 25 connecting a longitudinal edge of the upper wall 23 to a longitudinal edge of the lower wall 24). In other less preferred embodiments, the upper wall 23 and the lower wall 24 can be connected to each other by any number of longitudinal walls 25. The upper wall 23 and the lower wall 24 of the casing are preferably connected to each other by two transverse side walls 28 (each of the two transverse side walls 28 connecting a transverse edge of the upper wall 23 to a transverse edge of the lower wall 24).

Advantageously, the main plane of the upper wall 23 and the main plane of the lower wall 24 are parallel to each other. Preferably, the main planes of the longitudinal side walls 25 are parallel to each other. Preferably, the main planes of the transverse side walls 28 are parallel to each other. Even more advantageously, the main planes of the upper 23 and lower 34 walls are perpendicular to the main planes of the two longitudinal side walls 25 and to the main planes of the two transverse side walls 28. In a particularly preferred way, the casing 21 according to the invention has a parallelepiped shape, even more preferentially a rectangular parallelepiped shape.

Each of the walls of the casing 21 can independently have a rectangular parallelepiped shape, preferably each of the walls of the casing 21 has a rectangular parallelepiped shape.

The upper wall 23 or one of the longitudinal side walls 25 (intended not to be in contact with a glazed wall 27 of the glazing 10 when the casing is placed in a glazing) comprises a plurality of perforations 26 arranged periodically. Thus, the casing 21 according to the invention is also referred to as “perforated (rectilinear) casing” in the present text. The perforations 26 are made over the entire thickness of the wall and place the chamber of the casing 21 in fluid communication with the environment outside the casing 21.

In this second variant, the wall of the casing 21 comprising the periodic perforations 26 corresponds to the polymer foam plate comprising a plurality of perforations arranged periodically of the device described hereinbefore, and the chamber of the casing 21 corresponds to the chamber delimited by the polymer foam plate described hereinbefore. Thus, all that is described in the present text in relation to the perforated polymer foam plate and in relation to the chamber delimited by the perforated polymer foam plate applies to the perforated wall of the casing 21 and to the chamber of the casing, respectively. Similarly, everything described in this text in relation to polymer foam applies to the polymer foam walls of the profile 1.

The perforations can be made in the same way as for the first variant.

In this variant, the thickness of the chamber inside the casing 21 is the distance between the wall of the casing comprising the periodic perforations (the upper wall 23 or one of the longitudinal side walls 25) and the wall opposite this wall.

Advantageously, the device is a single-piece unit. For example, the device can be manufactured in a single piece by injection molding.

In a particularly preferred way, in reference to FIG. 4, according to a third variant, the width of the casing 21 is less than the thickness of the cavity between the glazed walls 27 (in the same direction) of the glazing 30 wherein it is intended to be placed. Thus, in this variant, the device is preferably not a spacer device, but the device may instead be associated with a spacer distinct therefrom. Preferably, at least one of the longitudinal side walls 25 (one or both) is not in contact with a glazed wall 27 when the casing is placed in a glazing 30.

The width of the casing 21 can be from 1 to 99% of the thickness of the cavity between the glazed walls of the glazing, for example from 1 to 10%, or from 10 to 20%, or from 20 to 30%, or from 30 to 40%, or from 40 to 50%, or from 50 to 60%, or from 60 to 70%, or from 70 to 80%, or from 80 to 90%, or from 90 to 99% of the thickness of the cavity between the glazed walls 27. The width of the casing 21 may be from 5 mm to less than the thickness of the cavity between the glazed walls 27, for example the width of the casing 21 may be from 5 mm to 29 mm, or from 5 mm to 19 mm, or from 5 mm to 15 mm.

The length of the casing 21 may be less than or equal to the length of the cavity between the glazed walls 27 of the glazing 30 wherein it is intended to be placed, in the same direction. Preferably, it is less than the length of the cavity in the same direction. The length of the casing 21 can be from 1 to 100% of the length of the cavity, for example from 1 to 10%, or from 10 to 20%, or from 20 to 30%, or from 30 to 40%, or from 40 to 50%, or from 50 to 60%, or from 60 to 70%, or from 70 to 80%, or from 80 to 90%, or from 90 to 95%, or from 95 to 100% of the length of the cavity between the glazed walls 27. In certain embodiments, the length of the casing 21 can be from 5 cm to the length of the cavity between the glazed walls 27 (in the same direction as the length of the casing 21).

In this third variant, the upper wall 23 or one of the longitudinal side walls 25 (intended not to be in contact with a glazed wall 27 of the glazing 30 when the casing is placed in a glazing) comprises a plurality of perforations 26 arranged periodically. The perforations 26 are made over the entire thickness of the wall and place the chamber of the casing 21 in fluid communication with the environment outside the casing 21.

The perforations can be made in the same way as in the first variant.

In this third variant, when the casing 21 is associated with a spacer device, the casing 21 can be placed, for example, on a conventional spacer device. More preferentially, the lower wall 24 of the casing 21 can rest on the spacer device. The spacer device in this variant can be a conventional spacer device. Advantageously, the spacer device is placed at the edge of the glazed walls 17 in a glazing 20 (between two glazed walls 17). It can be made of a rigid material, for example, a metal material, preferably aluminum and/or stainless steel, and/or a polymer material, and comprise two wings in contact with the respective glazed walls, and a connecting part between the two wings ensuring that the glazed walls are held at a given spacing. When the length of the casing 21 is less than the length of the cavity between the glazed walls, the casing 21 can be located in any location in the peripheral zone of the cavity of the glazing.

Advantageously, the device according to this variant is a single-piece unit. For example, the device can be manufactured in a single piece by injection molding.

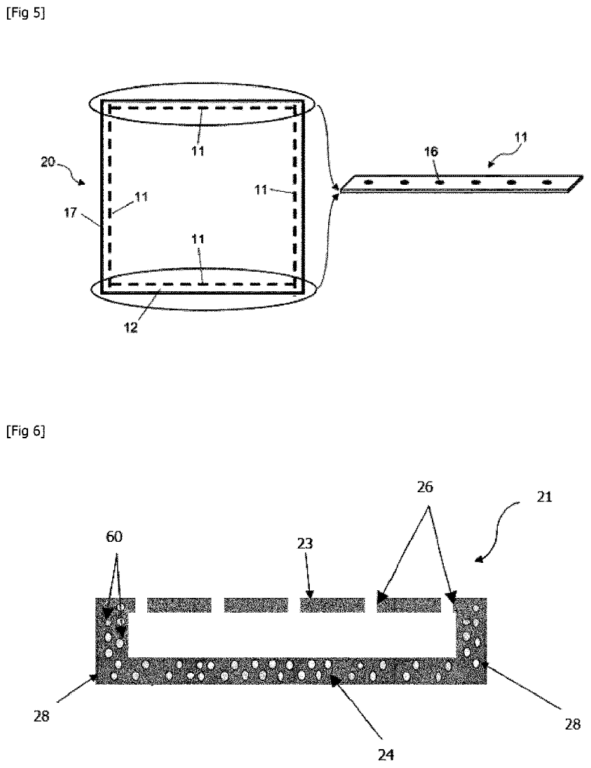

Referring to FIG. 5, according to a fourth variant, the acoustic insulation device according to the invention comprises at least one rectilinear bar 11. “Bar” means a solid of rectangular parallelepiped shape. The bar comprises a plurality of perforations 16 arranged periodically. Thus, the bar 11 according to the invention is also referred to as “perforated (rectilinear) bar” in the present text.

In this fourth variant, the bar 11 forms the polymer foam plate comprising a plurality of periodically arranged perforations of the device, as described above, and is associated with a spacer device separate therefrom. The chamber 12 is delimited by the polymer foam plate (bar 11) and by the spacer device (not shown in the figure). Thus, all that is described in the present text in relation to the perforated polymer foam plate and the chamber delimited by the perforated polymer foam plate applies to the perforated bar 11 and the chamber 12 delimited by the bar 11 and by the spacer device, respectively.

In this variant, the polymer foam preferably comprises an average proportion of open cells from 30 to 100%, preferably from 65 to 100%, more preferably from 70 to 100%, more preferably from 80 to 100%, more preferably from 85 to 100%, more preferably from 90 to 100%, more preferably from 95 to 100%. In some embodiments, the proportion of open cells in the polymer foam may be 65%, 70%, 75%, 80%, 85%, 90%, 95%, 98%, 99% or 100%. The proportion of open cells is preferably 100%.

The spacer device in this variant can be a conventional spacer device. Advantageously, the spacer device is placed at the edge of the glazed walls 17 in a glazing 20 (between two glazed walls 17). It can be made of a rigid material, for example, a metal material, preferably aluminum and/or stainless steel, and/or a polymer material, and comprise two wings in contact with the respective glazed walls, and a connecting part between the two wings ensuring that the glazed walls are held at a given spacing. The perforated bar 11 can be attached to the spacer device or simply positioned adjacent to the spacer device.

In this fourth variant, the thickness of the chamber 12 corresponds to the dimension of the chamber between the perforated bar 11 and the edge of the glazed walls 17.

Advantageously, the length of the bar 11 is equal to the length of the cavity between the glazed walls 17 of the glazing 20 wherein it is intended to be placed, in the same direction.

A description will now be given of various embodiments of the glazing device, wherein desiccant agents are present. More particularly, these different embodiments aim to describe different configurations/layouts/arrangements of said desiccant agents.

For the sake of simplicity, the description of these embodiments is carried out assuming that the glazing device conforms to that described above with reference to FIG. 2 and FIG. 3. Of course, the invention is not limited to such considerations, and all the embodiments described below can be adapted without difficulty, according to any technically operative combinations, to other configurations described previously.

FIG. 6 schematically shows a longitudinal cross-sectional view taken in plane XZ of a particular embodiment of the device 21 shown in FIG. 3.

As shown in FIG. 6, the granulated desiccant agent 60 is integrated into the walls of device 21. FIG. 6 shows that the desiccant agent is integrated into the lower wall 24 and two transverse side walls 28. Of course, the desiccant agent can also be incorporated into the upper wall 23 and/or the longitudinal side walls 25. In the case of a device 1 in profile form, the desiccant agent can be integrated into the upper wall 3 and/or the side walls 5.

Such a device wherein the desiccant agent is integrated into the polymer foam walls can be achieved by injecting the desiccant agent into the foam cells of the walls.

This advantageously prevents any release of granules 60 through the perforations 26 of the upper wall 23.

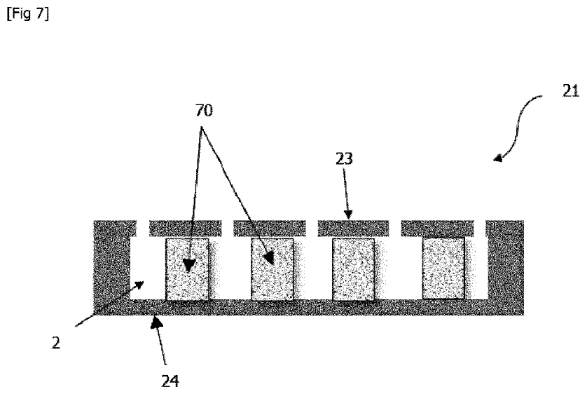

FIG. 7 schematically shows a longitudinal cross-sectional view taken in plane XZ of a still another particular embodiment of the device 21 shown in FIG. 3.

As shown in FIG. 7, the device 1 comprises a desiccant agent arranged in four envelopes 70. The envelopes 70 can be held in a fixed position inside the chamber 2. Said envelopes 70 can be held in a fixed position by (direct) contact of each of them with the inner wall of the chamber 2, by any method known to the skilled person, for example using an adhesive.

Furthermore, the embodiment of FIG. 7 has been described in terms of the presence of four envelopes 70. It should however be noted that the number of envelopes does not constitute a limitation of the invention. Thus, there is nothing to rule out the possibility of a single envelope, two envelopes, three envelopes or more than four envelopes.

Regardless of the number of envelopes envisaged, the positioning thereof within the chamber 2 also does not constitute a limitation of the invention. For example, in the case of the device in the form of a casing 21 (e.g., second variant and third variant), the casings are advantageously in (direct) contact only with the upper wall 23 and lower wall 24 of the chamber 2, as shown in FIG. 7. However, the casings can also be in (direct) contact with the side walls (transverse and/or longitudinal). In the case of the device comprising a bar 11 forming a polymer foam plate and associated with a spacer device (e.g., fourth variant), the envelopes can be in (direct) contact with the perforated bar (perforated polymer foam plate) and the spacer device. The envelopes can also be arranged at opposite ends of the chamber 2 delimited by the perforated bar and the spacer. Preferably, the envelopes are arranged so as to leave said perforations 6 free.

According to other embodiments not shown, the acoustic insulation device according to the invention comprises the desiccant agent which is maintained in a fixed position in the chamber and comprises a plate, a so-called “absorbent” plate, made from a solid material, for example a material such as those mentioned above with reference to the granules shown in FIG. 6. The plate is a rigid element with a (substantially) flat surface.

More particularly, when the device is a profile or a casing, the absorbent plate can extend horizontally over the entire inner surface of the lower wall of the acoustic insulation device, without occupying the entire volume of the chamber. The absorbent plate can be held in a fixed position on the inner surface of the lower wall by any method known to the skilled person, for example using an adhesive. Alternatively, the absorbent plate can be attached to the outside of the device, or even integrated into a wall of the device, such as the lower wall.

The desiccant agents have so far been described as being maintained in a fixed position in the chamber of the device. However, the invention is not limited to these considerations, as the invention covers still other embodiments wherein all or part of said desiccant agents are not fixed. These other embodiments are preferentially implemented when the acoustic insulation device is positioned in the lower part of the glazing, so that the desiccant agents not held in a fixed position cannot escape through the perforations due to the action of gravity.

In other, non-illustrated, embodiments, the acoustic insulation device comprises desiccant agents formed by bars made of a solid material having, for example, the same characteristics as those described with reference to the absorbent plate.

Said bars can be held outside the chamber, and positioned in contact with the acoustic insulation device, for example in contact with the inner face of the perforated polymer foam plate, each bar being separated from an adjacent bar by a perforation. Furthermore, each bar may be maintained in a fixed position by any method known to a person skilled in the art, for example using an adhesive.

The number of bars can be from 2 to 12, in particular from 4 to 8.

The device according to the invention may be according to several of the variants described hereinbefore at a time. Thus, the device according to the invention may simultaneously comprise one or more perforated profiles 1 and one or more perforated bars 11; simultaneously one or more perforated profiles 1 and one or more perforated casings 21; simultaneously one or more perforated bars 11 and one or more perforated casings 21; or simultaneously one or more perforated profiles 1, one or more perforated bars 11 and one or more perforated casings 21.

The device according to the invention may comprise a single perforated polymer foam plate. In particular, the device according to the invention can comprise a single rectilinear profile 1 comprising perforations 6 in its upper wall 3 or a single perforated rectilinear bar 11 or a single perforated rectilinear casing 21. However, preferably, the device comprises several perforated polymer foam plates. More particularly, it advantageously comprises several rectilinear profiles 1 each comprising an upper wall 3 comprising perforations 6 arranged periodically and/or several rectilinear bars 11 comprising perforations 16 arranged periodically and/or several rectilinear casings 21 comprising perforations 26 arranged periodically in one of its walls. When the device comprises several perforated polymer foam plates, for example several perforated rectilinear profiles 1 and/or perforated rectilinear bars 11 and/or perforated casings 21, said perforated polymer foam plates, perforated rectilinear profiles 1, perforated rectilinear bars 11 and perforated rectilinear casings 21 each independently may be as described hereinbefore.

Preferably, when the device comprises several perforated polymer foam plates, at least some of them are different from one another and they can all be different from one another and/or at least certain chambers delimited by said perforated polymer foam plates are different from one another and they can all be different from one another. In particular, when the device comprises several perforated rectilinear profiles 1, preferably at least some of them are different from one another and they can all be different from one another. More particularly, they may have perforations 6 with a different periodicity, that is to say perforations 6 of different size and/or perforations 6 arranged differently in the upper wall 3 (for example the distance between the centers of two adjacent perforations 6 may be different). Alternatively, or additionally, they may have an upper wall 3 of different thickness and/or a chamber 2 of different thickness. When the device comprises several perforated bars 11, preferably at least some of them are different from one another and they can all be different from one another. In particular, they may have perforations 16 with a different periodicity, that is to say perforations 16 of different size and/or perforations 16 arranged differently (for example the distance between the centers of two adjacent perforations 16 may be different), and/or have a different thickness. Alternatively, or additionally, at least some chambers 12 may be different from one another and they may all be different from one another, in particular the chambers 12 may have a different thickness. When the device comprises several perforated rectilinear casings 21, preferably at least some of them are different from one another and they can all be different from one another. More particularly, they may have perforations 26 with a different periodicity, that is to say perforations 26 of different size and/or perforations 26 arranged differently in the wall (for example the distance between the centers of two adjacent perforations 26 can be different). Alternatively, or additionally, they can have a wall having the perforations of different thickness and/or a chamber of different thickness. Thus, preferably, the perforated polymer foam plates (in particular the perforated rectilinear profiles 1 and/or the perforated rectilinear bars 11 and/or the perforated rectilinear casings 21) and the chambers that they delimit are such that at least some of the perforated polymer foam plates, or all of them, resonate, with the chambers that they delimit, at different frequencies.

The device may comprise two or at least two perforated polymer foam plates (for example, two or at least two perforated rectilinear profiles 1 and/or perforated rectilinear bars 11 and/or perforated rectilinear casings 21) (as described hereinbefore), or three or at least three perforated polymer foam plates (for example, three or at least three perforated rectilinear profiles 1 and/or perforated rectilinear bars 11 and/or perforated rectilinear casings 21), or four or at least four perforated polymer foam plates (for example, four or at least four perforated rectilinear profiles 1 and/or perforated rectilinear bars 11 and/or perforated rectilinear casings 21), or five or at least five perforated polymer foam plates (for example, five or at least five perforated rectilinear profiles 1 and/or perforated rectilinear bars 11 and/or perforated rectilinear casings 21). Preferably, at least two of the perforated polymer foam plates (for example at least two of the perforated profiles 1 and/or the perforated bars 11 and/or the perforated casings 21) have perforations with a different periodicity (that is to say the periodicity of the perforations of a polymer foam plate (for example of a profile 1 or of a bar 11 or a casing 21) is different from the periodicity of the perforations of another polymer foam plate (for example of another profile 1 or of another bar 11 or of another casing 21), more preferentially, at least three of the perforated polymer foam plates (for example at least three of the perforated profiles 1 and/or of the perforated bars 11 and/or of the perforated casings 21) have perforations with a different periodicity.

In a particularly preferred manner, the device according to the invention comprises three perforated polymer foam plates, and more particularly three perforated rectilinear profiles 1 and/or perforated rectilinear bars 11 and/or perforated rectilinear casings 21, or at least three perforated polymer foam plates, more particularly at least three perforated rectilinear profiles 1 and/or perforated rectilinear bars 11 and/or perforated rectilinear casings 21, and more preferably four (or at least four) perforated polymer foam plates, and more particularly four (or at least four) perforated rectilinear profiles 1 and/or perforated rectilinear bars 11 and/or perforated rectilinear casings 21. More preferentially three or at least three of these polymer foam plates (in particular three or at least three of these profiles 1 and/or bars 11 and/or casings 21), with the chambers that they delimit, are configured to resonate at different frequencies.

The acoustic insulation device according to the invention may further comprise one or more non-perforated plates and/or one or more plates comprising non-periodic perforations. The non-perforated plates and/or the plates comprising non-periodic perforations can be made of polymer foam, and/or of metal material, preferably aluminum and/or stainless steel, and/or polymer material, preferably polyethylene, polycarbonate, polypropylene, polystyrene, polybutadiene, polyisobutylene, polyester, polyurethane, polymethyl methacrylate, polyacrylate, polyamide, polyethylene terephthalate, polybutylene terephthalate, acrylonitrile, butadiene styrene, acrylonitrile styrene acrylate, styrene-acrylonitrile copolymer, or a combination thereof, the polymer material being optionally reinforced with glass fibers.

Preferably, the device comprises as many polymer foam plates (more particularly casings and/or bars) as the number of sides of the glazed walls of the glazing wherein it is intended to be placed, for example it comprises four polymer foam plates.

The polymer foam plates of the device may be disjointed (all or some of them) or may be joined to one another (all or some of them), preferably at their ends. Preferably, when the device according to the invention is a spacer device, all the polymer foam plates of the spacer device are joined so as to form a frame. When the polymer foam plates are joined, they can form a single piece (the polymer foam plates originate for example from a single polymer foam plate folded in one or more locations, for example to form the corners of the frame) or may be assembled together by any suitable means, for example by means of staples, glue, clips and/or interlocking. In particular, when the device comprises profiles 1, these may be disjointed (all or some of them) or may be joined to one another (all or some of them), preferably at their ends. Preferably, all the profiles 1 of the device are joined so as to form a frame. When the profiles 1 are joined, they can form a single piece (the rectilinear casings originate for example from a single casing folded in one or more locations, for example to form the corners of the frame) or may be assembled together by any suitable means, for example by the means indicated hereinbefore. Likewise, when the device comprises rectilinear bars 11, the latter may be disjointed (all or some of them) or may be joined to one another (all or some of them), preferably at their ends. Preferably, all the bars of the device are joined so as to form a frame. When the bars are joined, they can form a single piece or can be assembled together by any suitable means, for example by the means indicated hereinbefore. Likewise, when the device comprises casings 21, these may be disjointed (all or some of them) or may be joined to one another (all or some of them), preferably at their ends. Preferably, all the casings 21 of the device are joined so as to form a frame. When the casings 21 are joined, they can be assembled together by any suitable means, such as those described above.

When the device comprises several polymer foam plates, the chambers that they delimit (for example the chambers 2 in the profiles 1 of the device and/or the chambers 12 delimited by the rectilinear bars 11 and by the edges of the glazing) can be closed relative to one another (that is to say that they are not directly in fluid communication with one another), for example by the presence of a partition between the chambers, or may be communicating with one another, or some may be closed relative to one another and others communicating with one another. However, when the polymer foam plates of the device belong to perforated rectilinear casings 21, the chambers that they delimit, that is to say the chambers inside said casings 21, are closed relative to one another (that is to say, they are not directly in fluid communication with one another).

The invention also relates to a glazing comprising a device as described hereinbefore.

The glazing according to the invention comprises at least two glazed walls. Advantageously, the glazed walls are parallel or substantially parallel to one another.

In some embodiments, the glazing according to the invention may comprise exactly two glass walls (it is then called “double glazing”), or exactly three glass walls (it is then called “triple glazing”), or at least three glass walls, for example four glass walls (it is then called “quadruple glazing”).

Within the meaning of the present invention, a “glazed wall” refers to any structure comprising (or consisting of) at least one glass sheet or a glazed assembly. “Glazed assembly” is understood to mean a multilayer glazed element of which at least one layer is a glass sheet. Thus, the glazed walls may for example independently comprise a single glass sheet or alternatively a glazed assembly, for example one made of a laminated glazing (as described in more detail below).

The glass sheet can be made of organic or mineral glass. It can be made of tempered glass.

The glazed walls (or one of the glazed walls) may comprise (or consist of) a glazed assembly comprising at least one glass sheet which may be as described above. The glazed assembly is preferably a laminated glazing. The term “laminated glazing” is understood to mean at least two glass sheets between which at least one interlayer film generally made of viscoelastic plastic material is inserted. The interlayer film made of viscoelastic plastic material may comprise one or more layers of a viscoelastic polymer such as polyvinyl butyral (PVB) or an ethylene vinyl acetate copolymer (EVA), or an ethylene copolymer (corresponding to the definition of an ionomer), more preferentially PVB. The interlayer film can be made of standard PVB or of acoustic PVB (such as single-layer or tri-layer acoustic PVB). Acoustic PVB generally consists of three layers: two outer layers of standard PVB and an inner layer of PVB with added plasticizer so as to make it less rigid than the outer layers. The use of glazed walls comprising a laminated glazing makes it possible to improve the acoustic insulation of the glazing, the acoustic insulation being further increased when the interlayer film is made of acoustic PVB.

Each glazed wall includes two main faces opposite one another corresponding to the faces of the glazed wall having the largest surface areas. Advantageously, the glazed walls independently have a thickness (between their two main faces) greater than or equal to 1.6 mm, for example a thickness of 1.6 to 24 mm, preferably of 2 to 12 mm, more preferably of 4 to 10 mm, for example 4 or 6 mm. The glazed walls of the glazing according to the invention may all have the same thickness or have different thicknesses. The greater the thickness and/or the higher the density of the glazed walls, the greater the acoustic insulation. Furthermore, the thicker the glazed walls, the lower the mass/spring/mass of the glazing.

Preferably, all the glazed walls of the glazing have identical height and width. The glazing according to the invention may have any possible form, and preferably has a quadrilateral shape, in particular a rectangular or substantially rectangular shape. Alternatively, the glazing may have a circular, or substantially circular, shape, or an elliptical, or substantially elliptical shape, or a trapezoidal or substantially trapezoidal shape.

The glazed walls define a cavity between them. Each of the glazed walls defining the cavity comprises an inner face corresponding to the main face of the glazed wall facing the cavity in question and an outer face corresponding to the second main face of the glazed wall, that is to say corresponding to the main face of the glazed wall opposite the face facing the cavity.

Advantageously, the device according to the invention is positioned in the cavity of the glazing, more particularly in a peripheral zone of the cavity of the glazing. By “peripheral zone of the cavity” means an area of the cavity adjacent to the edges of the glazed walls and preferably whose width (that is in a direction orthogonal to the edge of the glazed walls, in the plane of the glazed walls) is less than or equal to 20 cm, more preferably less than or equal to 10 cm, more preferably less than or equal to 5 cm.

Preferably, one or more perforated polymer foam plates of the device according to the invention are each parallel to an edge of the glazed walls.

In a particularly preferred way, the device is placed in the cavity of the glazing so that the chamber delimited by the perforated polymer foam plate is in fluid communication with the cavity of the glazing formed between the glass walls via the perforations in the polymer foam plate. Thus, preferably, when the device comprises at least one perforated profile 1, it is placed in the cavity of the glazing so that the upper wall 3 of the profile(s) 1 faces the inside of the cavity of the glazing, the lower wall 4 of the profile(s) 1 being turned toward the outside and the edges of the glazing. Thus, the chamber 2 of the perforated profile(s) 1 is in fluid communication with the cavity of the glazing via the perforations 6 present in the upper wall 3 of said profiles 1 (that is to say that a fluid, and preferably a gas, can circulate from the cavity of the glazing to the inside of the chamber 2 of the profiles 1, and vice versa). When the device comprises at least one perforated bar 11, it is placed in the cavity of the glazing so that the wall having the periodic perforations 16 is facing the interior of the cavity of the glazing. When the device comprises at least one perforated casing 21, it is placed in the cavity of the glazing so that the wall having the periodic perforations 26 is either facing the center of the cavity of the glazing, or facing a glazed wall without being in contact with same.

When the device is a spacer device, the two glazed walls are attached to the spacer device.

More preferentially, when the spacer device comprises at least one perforated profile 1, the two glazed walls are attached to the side walls 5 of the profile(s) 1 of the spacer device, even more preferentially their inner face is attached each to a side wall 5 of the profile(s) 1 of the spacer device. When the spacer device comprises at least one perforated casing 21, the two glazed walls are attached to the side walls 25 of the casing(s) 21 of the spacer device, even more preferentially their inner face is attached each to a longitudinal side wall 25 of the casing(s) 21 of the spacer device.

When the device comprises at least one perforated bar 11, the two glazed walls are preferentially attached to opposite side faces of the bar 11. Advantageously, the glazed walls are attached to the device according to the invention by gluing, for example by an adhesive, such as a polyisobutylene (PIB)-based adhesive, by a silicone sealant or by double-sided adhesive tape.

A tightness seal can also be present, preferably arranged on the outer face of the device (that is to say the face of the device closest to the edge of the glazed walls), which is preferably the outer face of the lower wall 4 of the profile(s) 1 (when the device comprises at least one perforated profile 1). More preferentially, the tightness seal extends from this outer face to the edge of the glazed walls. This tightness seal can be formed by a mastic (referred to as “sealant mastic”) based on polyurethane, polysulfide and/or silicone. However, when the device comprises a perforated bar 11, preferably no tightness seal is present on said bar.

When the device according to the invention is a spacer device, or when the device is not a spacer device but is associated with a spacer device, the spacer device is used to set the length of the spacing between the glazed walls. The length of this spacing (that is to say, the thickness of the cavity between the glazed walls) can be from 6 to 30 mm, preferably from 10 to 20 mm, for example 16 mm.

Preferably, the cavity of the glazing (between the glazed walls) comprises a gas. The gas may be air and/or carbon dioxide, and/or argon, and/or krypton and/or xenon. The use of argon, krypton or xenon, in addition to or as a replacement for air, makes it possible to improve the thermal insulation of the glazing.

The glazing according to the invention can be totally opaque, totally transparent, or partially opaque and partially transparent. Preferably, the glazing is at least partially transparent.

One (or more) of the glazed walls may be tinted in its thickness over all or part of its surface. One (or more) of the glazed walls may be entirely or partly covered with an opaque coating, for example a paint and/or an enamel. The opaque coating may be present on the inner face of the glazed wall, or on its outer face, or on both faces, preferably it coats the inner face of the glazed wall. In some embodiments, only one of the glazed walls of the glazing is covered with an opaque coating. This glazed wall is advantageously the glazed wall intended to be the outermost glazed wall of the glazing when the latter is used in a building facade or exterior window.

In some embodiments, the glazed walls of the glazing, or at least one of the glazed walls, may have undergone a treatment in order to improve the thermal insulation of the glazing. In particular, the glazed wall(s) may comprise one (or more) insulating layer(s) such as an insulating layer based on metal and/or metal oxide, on one or more of their main faces, preferably on the inner face. When the glazed wall is also covered with an opaque coating (such as an enamel and/or a paint), an insulating layer compatible with the opaque coating is preferably used. Alternatively, the insulating layer and the opaque coating can be arranged on different faces of the glazed wall (for example, the insulating layer may be on the inner face and the opaque coating on the outer face). Again alternatively, when at least one of the glazed walls is a glazed assembly, the insulating layer can be interposed in the glazed assembly, for example between a PVB layer and a glass sheet.

Advantageously, at least one of the perforated polymer foam plates of the device and the chamber that it delimits are such that the assembly consisting of said perforated polymer foam plate and said chamber resonates at the so-called “mass/spring/mass” frequency of the glazing (for example, at least one of the profiles 1 of the device comprising, on its upper wall 3, perforations 6 arranged periodically is such that it resonates at the mass/spring/mass frequency of the glazing and/or at least one of the bars 11 comprising perforations 16 arranged periodically and the chamber 12 that it delimits are such that they resonate at the mass/spring/mass frequency of the glazing and/or at least one of the casings 21 comprising perforations 26 arranged periodically is such that it resonates at the mass/spring/mass frequency of the glazing). The presence in the glazing according to the invention of polymer foam plates and chambers configured to resonate at the mass/spring/mass frequency of the glazing or at a frequency close to same makes it possible to increase the loss of transmission of sound at the frequencies close to the mass/spring/mass frequency of the glazing but also at the frequencies higher than the mass/spring/mass frequency.

The mass/spring/mass frequency fₘₛₘ of the glazing may be determined by the following formula:

$${f}_{msm} = \frac{1}{2 π} \sqrt{\frac{{ρ}_{0} {c}_{0}^{2}}{d} ( \frac{{m}_{s 1} + {m}_{s 2}}{{m}_{s 1} {m}_{s 2}} )} \qquad [ Math . 2 ]$$

In equation 2, ρ₀ is the density of the air in kg/m³, c₀ is the speed of sound in the air cavity in m/s, d is the thickness of the air cavity between the two glass walls in m and mₛ₁ and mₛ₂ are respectively the masses per surface area unit of the first and second glass wall in kg/m².

Preferably, at least one of the perforated polymer foam plates of the device and the chamber delimited thereby (more particularly at least one of the profiles 1 of the device comprising on its upper wall 3 perforations 6 arranged periodically and/or at least one of the bars 11 of the device comprising perforations 16 arranged periodically and the chamber 12 delimited thereby and/or at least one of the casings 21 of the device comprising perforations 26 arranged periodically) are configured to resonate at a frequency corresponding to one octave-third less than the mass/spring/mass frequency of the glazing, or at a frequency close thereto. This makes it possible to increase the loss of transmission of sound at the frequencies close to this frequency.

Preferably, at least one of the perforated polymer foam plates of the device and the chamber delimited thereby (more particularly at least one of the profiles 1 of the device comprising on its upper wall 3 perforations 6 arranged periodically and/or at least one of the bars 11 of the device comprising perforations 16 arranged periodically and the chamber 12 delimited thereby and/or at least one of the casings 21 of the device comprising perforations 26 arranged periodically) are configured to resonate at a frequency corresponding to one octave-third more than the mass/spring/mass frequency of the glazing, or at a frequency close thereto. This makes it possible to increase the loss of transmission of sound at the frequencies close to this frequency.

The presence, in the glazing, of a device comprising at least two perforated polymer foam plates delimiting a chamber (in particular at least two perforated profiles 1 and/or perforated rectilinear bars 11 and/or perforated rectilinear casings 21), at least one polymer foam plate of which forms with the chamber that it delimits a system configured to resonate at the mass/spring/mass frequency of the glazing and at least one other polymer foam plate forms with the chamber that it delimits a system configured to resonate at one octave-third greater than or less than the mass/spring/mass frequency of the glazing, and preferably at least three perforated polymer foam plates delimiting a chamber (in particular at least three perforated profiles 1 and/or perforated rectilinear bars 11 and/or perforated rectilinear casings 21), at least one polymer foam plate of which forms with the chamber that it delimits a system configured to resonate at the mass/spring/mass frequency of the glazing, at least one other polymer foam plate forms with the chamber that it delimits a system configured to resonate at one octave-third greater than the mass/spring/mass frequency of the glazing and at least one other polymer foam plate forms with the chamber that it delimits a system configured to resonate at one octave-third less than the mass/spring/mass frequency of the glazing, makes it possible to smooth out the sound transmission loss around the mass/spring/mass frequency of the glazing and improve the sound insulation of the glazing over a wider frequency band around the mass/spring/mass frequency of the glazing.

Even more preferably, the glazing according to the invention further comprises one or more additional acoustic insulation devices. Each additional acoustic insulation device comprises a plate comprising a plurality of periodically arranged perforations delimiting a chamber arranged in the cavity. Preferably, the periodicity of the perforations in the polymer foam plate of the device according to the invention and in the plate of each additional acoustic insulation device are different from one another.

For example, the glazing according to the invention may comprise:
a first acoustic insulation device according to the invention, as described above, comprising a first perforated polymer foam sheet delimiting a first chamber, the system constituted by the first perforated polymer foam sheet and the first chamber being configured to resonate at a first frequency,
a second additional acoustic insulation device comprising a second perforated plate delimiting a second chamber, the system constituted by the second perforated plate and the second chamber being configured to resonate at a second frequency corresponding to one octave-third below the first frequency, and
a third additional acoustic insulation device comprising a third perforated plate delimiting a third chamber, the system constituted by the third perforated polymer foam plate and the third chamber being configured to resonate at a third frequency corresponding to one octave-third above the first frequency.

Each additional acoustic insulation device can be a conventional acoustic insulation device. Alternatively or additionally, the plate of each additional acoustic insulation device may comprise a polymer foam, as defined above.

In advantageous embodiments, the glazing according to the invention may exhibit acoustic insulation (determined for example by measuring the acoustic weakening index, particularly according to standard ISO 10140) higher than an identical glazing but not comprising any perforations arranged periodically in the polymer foam plates of the device, over a frequency range from 200 Hz to 2000 Hz, preferably from 100 Hz to 5000 Hz, still preferably from 50 Hz to 20,000 Hz.

The glazing according to the invention can be used in any application that uses glazings. In particular, the glazing according to the invention can be a building glazing. The glazing can be intended to serve as an interface between the outside and the inside of the building and can be for example a facade glazing, window glazing or door glazing. Alternatively, the glazing can be intended to be placed inside the building.

The invention also relates to a method of manufacturing a glazing as described above comprising:
providing at least two glazed walls;
providing a device as described above;
arranging the two glass walls to form a cavity therebetween; and
inserting the device into the cavity.

In a particularly preferred way, the device is placed in the cavity of the glazing so that the chamber delimited by the perforated polymer foam plate of the device is in fluid communication with the cavity of the glazing via the perforations of the device polymer foam plate.

Preferably, when the device is a spacer device, the manufacturing method comprises a step of attaching the two glazed walls to the spacer device. More preferentially, when the spacer device comprises at least one perforated profile 1 or perforated casing 21, the two glazed walls are attached to the spacer device in such a way that the upper wall of the spacer device comprising the perforations arranged periodically faces the cavity formed between the glazed walls of the glazing.

1. A glazing comprising at least two glazed walls forming a cavity between the at least two glazed walls, wherein the cavity comprises at least one acoustic insulation device comprising at least one polymer foam plate, said at least one polymer foam plate comprising a plurality of perforations arranged periodically and delimiting a chamber arranged in the cavity.

2. The glazing according to claim 1, wherein the at least one acoustic insulation device comprises a profile or casing formed from a plurality of polymer foam walls, the chamber being an inner space of the profile or casing delimited by the at least two glazed walls, and the at least one polymer foam plate comprising the plurality of periodically arranged perforations being one of the at least two glazed walls of the profile or casing.

3. The glazing according to claim 1, wherein the at least one acoustic insulation device is a spacer device of the glazing.

4. The glazing according to claim 1, wherein the at least one acoustic insulation device comprises an inner part facing the chamber and an outer part facing away from the inner part, an average proportion of open cells of the polymer foam in the inner part being greater than a proportion of open cells in the outer part.

5. The glazing according to claim 1, wherein the at least one acoustic insulation device is a one-piece unit.

6. The glazing according to claim 1, wherein the at least one acoustic insulation device comprises at least one rectilinear bar forming said at least one polymer foam plate, associated with a spacer device, the chamber being delimited by the at least one polymer foam plate and by an edge of the glazing.

7. The glazing according to claim 6, wherein the at least one polymer foam comprises an average proportion of open cells of 30 to 99%.

8. The glazing according to claim 1, wherein the at least one polymer foam is selected from the group consisting of silicone foams, polyurethane foams, polyethylene foams, melamine foams, and combinations thereof.

9. The glazing according to claim 1, comprising a desiccant agent in or associated with the at least one acoustic insulation device.

10. The glazing according to claim 9, wherein the desiccant agent is incorporated into the at least one polymer foam.

11. The glazing according to claim 9, wherein the desiccant agent is arranged in at least one envelope.

12. The glazing according to claim 1, wherein said at least one polymer foam plate comprises at least three perforations.

13. The glazing according to claim 1, further comprising one or more additional acoustic insulation devices, each additional acoustic insulation device comprising a plate comprising a plurality of periodically arranged perforations and delimiting a chamber arranged in the cavity.

14. The glazing according to claim 13, wherein the plate of each additional acoustic insulation device comprises a polymer foam.

15. The glazing according to claim 1, wherein the at least one acoustic insulation device is positioned in a peripheral zone of the cavity of the glazing.

16. The glazing according to claim 1, being a glazing of a building or an interior glazing.

17. An acoustic insulation device comprising at least one polymer foam plate, said at least one polymer foam plate comprising a plurality of perforations arranged periodically, said acoustic insulation device being suitable for manufacturing a glazing according to claim 1.

18. The glazing according to claim 4, wherein the average proportion of open cells of the polymer foam in the inner part is between 30% and 99%.

19. The glazing according to claim 7, wherein the average proportion of open cells is from 65 to 98%.

20. The glazing according to claim 11, wherein the at least one envelope is held inside or outside the chamber.
